(19) United States
(12) Patent Application Publication
(10) Pub. No.: US 2023/0171717 A1
(43) Pub. Date: Jun. 1, 2023

(54) System Information Design For Synchronization In Non-Terrestrial Network Communications

(71) Applicant: MediaTek Singapore Pte. Ltd., Singapore (SG)

(72) Inventors: Abdelkader Medles, Cambridge (GB); Mehmet Kunt, Cambridge (GB); Gilles Charbit, Cambridge (GB); Pradeep Jose, Cambridge (GB)

(21) Appl. No.: 17/922,106

(22) PCT Filed: Apr. 28, 2021
(86) PCT No.: PCT/CN2021/090631

§ 371 Date: Oct. 28, 2022

Related U.S. Application Data
(60) Provisional application No. 63/016,342, filed on Apr. 28, 2020.

(51) Int. Cl. H04W 56/00; H04B 7/185

(52) U.S. Cl. CPC H04W 56/0015; H04B 7/18513; H04W 56/004

(57) ABSTRACT

Various solutions for system information design for synchronization in non-terrestrial network (NTN) communications are described. An apparatus (e.g., a UE) determines synchronization information with respect to an implicit time reference associated with a wireless network. Using the synchronization information, the apparatus maintains synchronization in performing NTN communications with the wireless network.

### CROSS REFERENCE TO RELATED PATENT APPLICATION(S)

The present disclosure is part of U.S. National Stage filing of International Patent Application No. PCT/CN2021/090631, filed on 28 Apr. 2021, which is part of a non-provisional application claiming the priority benefit of U.S. Patent Application No. 63/016,342, filed on 28 Apr. 2020, the contents of which being incorporated by reference in their entirety.

### TECHNICAL FIELD

The present disclosure is generally related to mobile communications and, more particularly, to system information design for synchronization in non-terrestrial network (NTN) communications.

### BACKGROUND

Unless otherwise indicated herein, approaches described in this section are not prior art to the claims listed below and are not admitted as prior art by inclusion in this section.

In NTN communications, in order to compensate for propagation delay and Doppler shift in wireless communications over a link, a user equipment (UE) needs to be aware of certain information. For example, the UE needs to know its UE position (e.g., via Global Navigation Satellite System (GNSS) positioning or a known position), the position and velocity of a satellite (or other flying object(s)) functioning as part of the NTN communications, and a time reference with respect to the position and velocity of the satellite. In case the satellite is a reference point, there would be no need for the UE to obtain information on a feeder link between a land-based network node (e.g., base station) and the satellite. In case the propagation delay includes the feeder, the UE would need to know either the position of the land-based network node or information related to the feeder link (e.g., feeder link delay and delay drift rate). In case there is switching delay due to processing at the satellite, the UE would also need to know the switching delay. For synchronization in the NTN communications, synchronization information needs to be signaled to the UE. However, there are some issues that need to be addressed. Such issues include, for example, how efficient the signaling to the UE is to be optimized, how the UE is to propagate the information to maintain synchronization, and when the UE is to receive the synchronization information.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure are believed to address issues pertaining to system information for synchronization in NTN communications.

In one aspect, a method may involve an apparatus determining synchronization information with respect to an implicit time reference associated with a wireless network. The method may also involve the apparatus maintaining synchronization using the synchronization information in performing NTN communications with the wireless network.

In another aspect, a method may involve an apparatus determining a feeder link delay associated with a feeder link between a terrestrial network node and a non-terrestrial (NT) network node of a wireless network. The method may also involve the apparatus maintaining synchronization using the feeder link delay in performing NTN communications with the wireless network.

In yet another aspect, a method may involve an apparatus determining either or both of: (i) synchronization information with respect to an implicit time reference associated with a wireless network, and (ii) a feeder link delay associated with a feeder link between a terrestrial network node and a NT network node of the wireless network. The method may also involve the apparatus maintaining synchronization using either or both of the synchronization information and the feeder link delay in performing NTN communications with the wireless network.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT),Narrow Band Internet of Things (NB-IoT), Industrial Internet of Things (IIoT) and non-terrestrial network (NTN), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to system information design for synchronization in NTN communications. According to the present disclosure, a number of possible solutions may be implemented separately or jointly. That is, although these possible solutions may be described below separately, two or more of these possible solutions may be implemented in one combination or another.

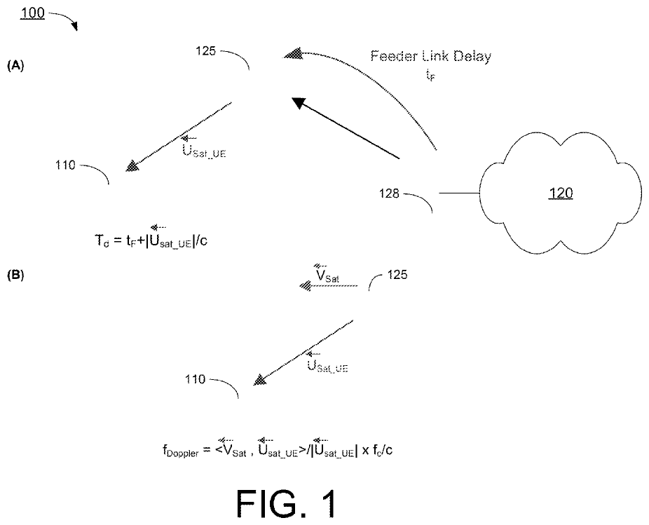

FIG. 1 illustrates an example network environment 100 in which various proposed schemes in accordance with the present disclosure may be implemented. Network environment 100 may involve a UE 110 and a wireless network 120 (e.g., an LTE network, a 5G network, an NR network, an IoT network, an NB-IoT network, an IIoT network or an NTN network). UE 110 may communicate with wireless network 120 via a non-terrestrial (NT) network node 125 (e.g., a satellite) and/or a terrestrial network node 128 (e.g., a gateway, base station, eNB, gNB or transmission/reception point (TRP)). Referring to part (A) and part (B) of FIG. 1, NT network node 125 may be moving at a speed of Vₛₐₜ with a relative motion/velocity of U_{sat_UE} with respect to UE 110, and there may be a feeder link delay t_{F} associated with the feeder link between terrestrial network node 128 and NT network node 125. Correspondingly, a propagation delay Td and a Doppler shift f_{Doppler} may result. In FIG. 1, f_{c} denotes the frequency of a carrier signal and c denotes the speed of light. Under various proposed schemes in accordance with the present disclosure, each of UE 110, NT network node 125 and terrestrial network node 128 may be configured to perform operations pertaining to system information design for synchronization in NTN communications, as described below.

Under a first proposed scheme in accordance with the present disclosure, implicit time reference may be used to avoid signaling of time information, thereby reducing overhead. Under the proposed scheme, information for synchronization (e.g., position, velocity and/or feeder link delay) may be assumed to be valid at a fixed reference corresponding to NT network node 125 or terrestrial network node 128 or gateway time. The fixed reference may correspond to a frame (e.g., system frame number (SFN)) boundary at or immediately after an ending boundary of a system information (SI)-window in which a corresponding system information block (SIB) is transmitted from NT network node 125 or terrestrial network node 128 to UE 110. Other options may be used as the fixed reference for the start of the frame or fixed offset from the start or end of the frame or a lot in which the SIB is transmitted.

Under a second proposed scheme in accordance with the present disclosure, feeder link delay drift rate may be utilized. Under the proposed scheme, instead of signaling the gateway position or gateway and relay satellite position to determine the feeder link delay, one alternative may be to signal the feeder link delay and the feeder link delay drift rate. Advantageously, this may allow saving on signaling overhead and may support different kinds of feeder link designs. Under the proposed scheme, feeder link delay at time t may be derived as follows: Delay_t=Delay_0+Drift_rate×t. Here, Delay_0denotes the feeder link delay at a reference time, Drift_ratedenotes the feeder link delay drift rate at the reference time, and t denotes the amount of time elapsed since the reference time.

Under a third proposed scheme in accordance with the present disclosure, air draft coefficient signaling may be utilized. It is believed that including information on the air draft coefficient in signaling may improve the propagation accuracy of the position and velocity of the NT network node 125 especially for case when NT network node 125 is a low-Earth-orbit (LEO) satellite. Under the proposed scheme, air draft coefficient (Dg) may be signaled as part of the synchronization information. Moreover, acceleration due to air drag may be expressed as follows: −Dg×∥\vec{V}ₜ∥×\vec{V}ₜ. Under the proposed scheme, alternative signaling and/or calculation of air draft may also be utilized.

Under a fourth proposed scheme in accordance with the present disclosure, a propagator for satellite position and/or velocity may be utilized. Under the proposed scheme, to keep up-to-date information of the position and/or velocity of a satellite (e.g., NT network node 125), a novel procedure may be performed. Under the procedure, it may be assumed that \vec{S}=(Sₓ, S_{y}, S_{z}) denote the satellite position in Earth-Centered, Earth-Fixed (ECEF) coordinates. It may also be assumed that \vec{V}=(Vₓ, V_{y}, V_{z}) denote the satellite velocity vector components in ECEF coordinates (relative to a fixed Earth). In performing the procedure, the Earth velocity vector \vec{V}=(Vₓₑ, V_{ey}, 0) may be added to the rotation of Earth to obtain the velocity in geodetic coordinates \vec{V}₀=\vec{V}+\vec{V}ₑ as follows: Vₑₓ=

$$- {w}_{0} \frac{{S}_{y}}{\sqrt{{S}_{x}^{2} + {S}_{y}^{2}}} , {V}_{ey} = - {w}_{0} \frac{{S}_{x}}{\sqrt{{S}_{x}^{2} + {S}_{y}^{2}}} ,$$

where w₀ may denote the Earth angular rotation of ˜7.27E-5 rad/sec. The initial satellite position in geodetic coordinates that coincide with ECEF coordinates at time t=0 may be \vec{S}₀=\vec{S}. Then, the updated velocity at time t after the time reference may be calculated as \vec{V}ₜ=\vec{V}ₒ+∫₀^{t} \vec{g}ᵤ du, where

$$\vec{{g}_{u}} = - {g}_{0} \frac{{R}_{0}^{2}}{{‖ \vec{{S}_{u}} ‖}^{3}} \vec{{S}_{u}} , {R}_{0}$$

may denote the Earth radius and g₀ may denote the gravity at Earth surface. Next, the updated satellite position at time t after the time reference may be calculated as follows: \vec{S}ₜ=\vec{S}ₒ+∫ₒ^{t} \vec{V}_{S} ds. It is noteworthy that low complexity solution may be made to propagate this equation over small intervals Δ as follows:

$$\vec{{V}_{t + Δ}} = \vec{{V}_{t}} + {\int }_{0}^{Δ} \vec{{g}_{t + u}} du - {D}_{g} {\int }_{0}^{Δ} ‖ \vec{{V}_{t + u}} ‖ \cdot \vec{{V}_{t + u}} du \approx \vec{{V}_{t}} + Δ \cdot \vec{{g}_{t}} - Δ \cdot {D}_{g} \cdot ‖ \vec{{V}_{t}} ‖ \cdot \vec{{V}_{t}}$$

$$\vec{{S}_{t + Δ}} = \vec{{S}_{t}} + {\int }_{0}^{Δ} \vec{{V}_{t + s}} ds = \vec{{S}_{t}} + Δ \cdot \vec{{V}_{t}} + {\int }_{0}^{Δ} {\int }_{0}^{s} \vec{{g}_{t + u}} du ds \approx \vec{{S}_{t}} + Δ \cdot \vec{{V}_{t}} + \frac{{Δ}^{2}}{2} \cdot \vec{{g}_{t}}$$

Here, Dg may denote the air draft coefficient in case signaled and it may be replaced by 0 if not signaled. The last step of the procedure may involve bringing back the satellite position and velocity to the ECEF coordinates as follows:

$$\vec{{V}_{t , ECEF}} = \vec{{V}_{t}} - \vec{{V}_{e}}$$

$$\vec{{S}_{t , ECEF}} = Rz ( - {w}_{0} t ) \vec{{S}_{t}}$$

$${R}_{z} ( θ ) = [ \begin{matrix}cos θ & - sin θ & 0 \\ sin θ & cos θ & 0 \\ 0 & 0 & 1\end{matrix} ]$$

Here, Rz(θ) may denote the rotation around the Z-axis in the XY plane with an angle θ.

### Illustrative Implementations

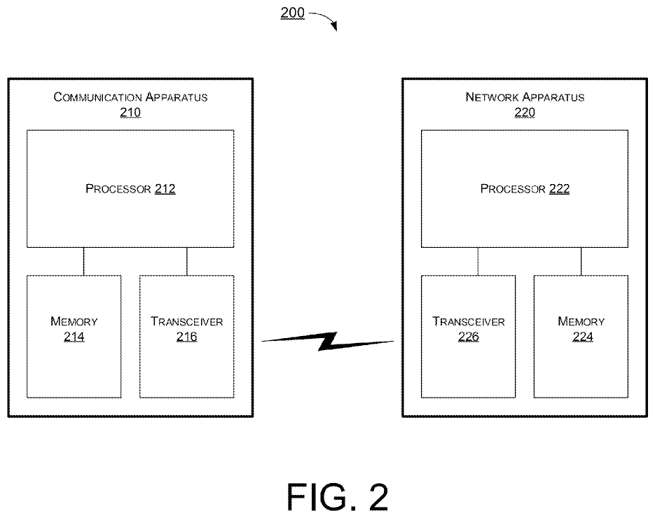

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to system information design for synchronization in NTN communications, including scenarios/schemes described above as well as processes 300, 400 and 500 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., NT network node 125 or terrestrial network node 128) of a communication network (e.g., network 120). It is also noteworthy that, although the example implementations described below are provided in the context of NTN communications, the same may be implemented in other types of networks.

Under a proposed scheme pertaining to system information design for synchronization in NTN communications in accordance with the present disclosure, with communication apparatus 210 implemented in or as UE 110 and network apparatus 220 implemented in or as NT network node 125 or terrestrial network node 128 in network environment 100, processor 212 of communication apparatus 210 may determine synchronization information with respect to an implicit time reference associated with a wireless network (e.g., network 120). Additionally, processor 212 may maintain, via transceiver 216, synchronization using the synchronization information in performing NTN communications with the wireless network.

In some implementations, in determining the synchronization information, processor 212 may determine the synchronization information without receiving the synchronization information in a signaling from the wireless network.

In some implementations, the synchronization information may include one or more of the following: (a) a position of a NT network node of the wireless network, (b) a velocity of the NT network node, (c) a position of a terrestrial network node of the wireless network, and (d) a feeder link delay associated with a feeder link between the terrestrial network node and the NT network node.

In some implementations, the position and the velocity may be according to ECEF coordinates.

In some implementations, the synchronization information may be valid at the implicit time reference which is a fixed reference corresponding to the NT network node or the terrestrial network node.

In some implementations, the implicit time reference may correspond to a frame boundary at an ending boundary of a system information window in which a corresponding SIB is transmitted from the wireless network to communication apparatus 210.

In some implementations, the implicit time reference may correspond to a frame boundary immediately after an ending boundary of a system information window in which a corresponding SIB is transmitted from the wireless network to communication apparatus 210.

In some implementations, the implicit time reference may correspond to a frame boundary at a starting boundary of a frame or slot in which a corresponding SIB is transmitted from the wireless network to communication apparatus 210.

In some implementations, the implicit time reference may correspond to a frame boundary at a fixed offset from a starting boundary of a frame or slot in which a corresponding SIB is transmitted from the wireless network to communication apparatus 210.

In some implementations, the implicit time reference may correspond to a frame boundary at a fixed offset from an ending boundary of a frame or slot in which a corresponding SIB is transmitted from the wireless network to communication apparatus 210.

Under a proposed scheme pertaining to system information design for synchronization in NTN communications in accordance with the present disclosure, with communication apparatus 210 implemented in or as UE 110 and network apparatus 220 implemented in or as NT network node 125 or terrestrial network node 128 in network environment 100, processor 212 of communication apparatus 210 may determine a feeder link delay associated with a feeder link between a terrestrial network node and a NT network node of a wireless network (e.g., network 120). Moreover, processor 212 may maintain, via transceiver 216, synchronization using the feeder link delay in performing NTN communications with the wireless network.

In some implementations, in determining the feeder link delay, processor 212 may determine the feeder link delay without receiving information of a position of a network node of the wireless network in a signaling from the wireless network.

In some implementations, in determining the feeder link delay, processor 212 may receive, via transceiver 216 and from the wireless network, a signaling indicating the feeder link delay at a reference time and a feeder link delay drift rate at the reference time.

In some implementations, in maintaining the synchronization using the feeder link delay, processor 212 may derive the feeder link delay at a given time based on the feeder link delay at the reference time, the feeder link delay drift rate at the reference time, and an amount of time elapsed from the reference time to the given time.

Under a proposed scheme pertaining to system information design for synchronization in NTN communications in accordance with the present disclosure, with communication apparatus 210 implemented in or as UE 110 and network apparatus 220 implemented in or as NT network node 125 or terrestrial network node 128 in network environment 100, processor 212 of communication apparatus 210 may determine either or both of: (i) synchronization information with respect to an implicit time reference associated with a wireless network (e.g., network 120), and (ii) a feeder link delay associated with a feeder link between a terrestrial network node and a NT network node of the wireless network. Furthermore, processor 212 may maintain, via transceiver 216, synchronization using either or both of the synchronization information and the feeder link delay in performing NTN communications with the wireless network.

In some implementations, in determining the synchronization information, processor 212 may determine the synchronization information without receiving the synchronization information in a signaling from the wireless network.

In some implementations, the synchronization information may include one or more of the following: (a) a position of a NT network node of the wireless network, (b) a velocity of the NT network node, (c) a position of a terrestrial network node of the wireless network, and (d) a feeder link delay associated with a feeder link between the terrestrial network node and the NT network node. In such cases, the synchronization information may be valid at the implicit time reference which is a fixed reference corresponding to the NT network node or the terrestrial network node.

In some implementations, the position and the velocity may be according to ECEF coordinates.

In some implementations, the synchronization information may be valid at the implicit time reference which is a fixed reference corresponding to the NT network node or the terrestrial network node.

In some implementations, the implicit time reference may correspond to a frame boundary at or immediately after an ending boundary of a system information window in which a corresponding SIB is transmitted from the wireless network to communication apparatus 210.

In some implementations, the implicit time reference may correspond to a frame boundary at a starting boundary, a fixed offset from the starting boundary, or a fixed offset from an ending boundary of a frame or slot in which a corresponding SIB is transmitted from the wireless network to communication apparatus 210.

In some implementations, in determining the feeder link delay, processor 212 may receive, via transceiver 216 and from the wireless network, a signaling indicating the feeder link delay at a reference time and a feeder link delay drift rate at the reference time.

In some implementations, in maintaining the synchronization using the feeder link delay, processor 212 may derive the feeder link delay at a given time based on the feeder link delay at the reference time, the feeder link delay drift rate at the reference time, and an amount of time elapsed from the reference time to the given time.

### Illustrative Processes

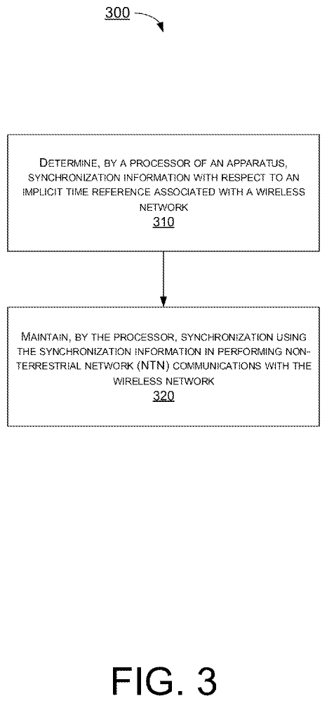

FIG. 3 illustrates an example process 300 in accordance with an implementation of the present disclosure. Process 300 may be an example implementation of schemes described above, whether partially or completely, with respect to system information design for synchronization in NTN communications in accordance with the present disclosure. Process 300 may represent an aspect of implementation of features of communication apparatus 210. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210 and network apparatus 220. Process 300 may begin at block 310.

At 310, process 300 may involve processor 212 of communication apparatus 210 determining synchronization information with respect to an implicit time reference associated with a wireless network (e.g., network 120). Process 300 may proceed from 310 to 320.

At 320, process 300 may involve processor 212 maintaining, via transceiver 216, synchronization using the synchronization information in performing NTN communications with the wireless network.

In some implementations, in determining the synchronization information, process 300 may involve processor 212 determining the synchronization information without receiving the synchronization information in a signaling from the wireless network.

In some implementations, the synchronization information may include one or more of the following: (a) a position of a NT network node of the wireless network, (b) a velocity of the NT network node, (c) a position of a terrestrial network node of the wireless network, and (d) a feeder link delay associated with a feeder link between the terrestrial network node and the NT network node.

In some implementations, the position and the velocity may be according to ECEF coordinates.

In some implementations, the synchronization information may be valid at the implicit time reference which is a fixed reference corresponding to the NT network node or the terrestrial network node.

In some implementations, the implicit time reference may correspond to a frame boundary at an ending boundary of a system information window in which a corresponding SIB is transmitted from the wireless network to communication apparatus 210.

In some implementations, the implicit time reference may correspond to a frame boundary immediately after an ending boundary of a system information window in which a corresponding SIB is transmitted from the wireless network to communication apparatus 210.

In some implementations, the implicit time reference may correspond to a frame boundary at a starting boundary of a frame or slot in which a corresponding SIB is transmitted from the wireless network to communication apparatus 210.

In some implementations, the implicit time reference may correspond to a frame boundary at a fixed offset from a starting boundary of a frame or slot in which a corresponding SIB is transmitted from the wireless network to communication apparatus 210.

In some implementations, the implicit time reference may correspond to a frame boundary at a fixed offset from an ending boundary of a frame or slot in which a corresponding SIB is transmitted from the wireless network to communication apparatus 210.

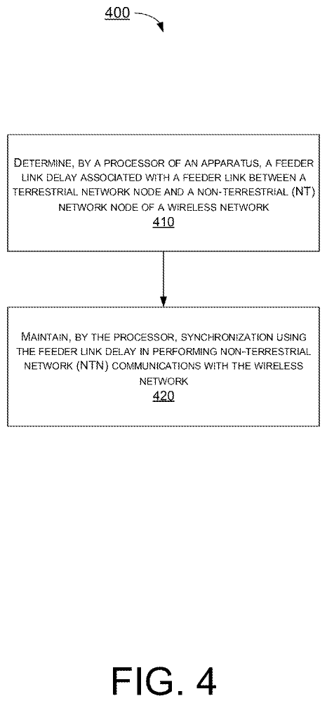

FIG. 4 illustrates an example process 400 in accordance with an implementation of the present disclosure. Process 400 may be an example implementation of schemes described above, whether partially or completely, with respect to system information design for synchronization in NTN communications in accordance with the present disclosure. Process 400 may represent an aspect of implementation of features of communication apparatus 210. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices. Solely for illustrative purposes and without limitation, process 400 is described below in the context of communication apparatus 210 and network apparatus 220. Process 400 may begin at block 410.

At 410, process 400 may involve processor 212 of communication apparatus 210 determining a feeder link delay associated with a feeder link between a terrestrial network node and a NT network node of a wireless network (e.g., network 120). Process 400 may proceed from 410 to 420.

At 420, process 400 may involve processor 212 maintaining, via transceiver 216, synchronization using the feeder link delay in performing NTN communications with the wireless network.

In some implementations, in determining the feeder link delay, process 400 may involve processor 212 determining the feeder link delay without receiving information of a position of a network node of the wireless network in a signaling from the wireless network.

In some implementations, in determining the feeder link delay, process 400 may involve processor 212 receiving, via transceiver 216 and from the wireless network, a signaling indicating the feeder link delay at a reference time and a feeder link delay drift rate at the reference time.

In some implementations, in maintaining the synchronization using the feeder link delay, process 400 may involve processor 212 deriving the feeder link delay at a given time based on the feeder link delay at the reference time, the feeder link delay drift rate at the reference time, and an amount of time elapsed from the reference time to the given time.

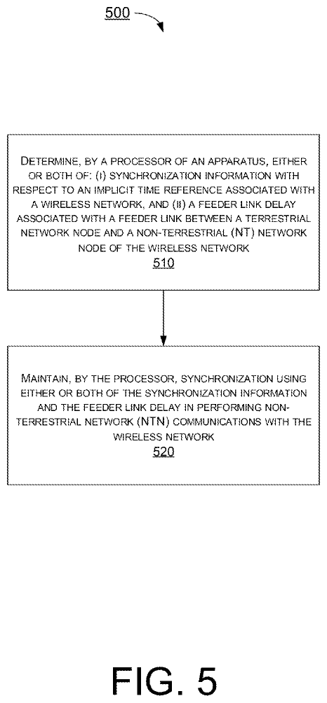

FIG. 5 illustrates an example process 500 in accordance with an implementation of the present disclosure. Process 500 may be an example implementation of schemes described above, whether partially or completely, with respect to system information design for synchronization in NTN communications in accordance with the present disclosure. Process 500 may represent an aspect of implementation of features of communication apparatus 210. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 210 or any suitable UE or machine type devices. Solely for illustrative purposes and without limitation, process 500 is described below in the context of communication apparatus 210 and network apparatus 220. Process 500 may begin at block 510.

At 510, process 500 may involve processor 212 of communication apparatus 210 determining either or both of: (i) synchronization information with respect to an implicit time reference associated with a wireless network (e.g., network 120), and (ii) a feeder link delay associated with a feeder link between a terrestrial network node and a NT network node of the wireless network. Process 500 may proceed from 510 to 520.

At 520, process 500 may involve processor 212 maintaining, via transceiver 216, synchronization using either or both of the synchronization information and the feeder link delay in performing NTN communications with the wireless network.

In some implementations, in determining the synchronization information, process 500 may involve processor 212 determining the synchronization information without receiving the synchronization information in a signaling from the wireless network.

In some implementations, the synchronization information may include one or more of the following: (a) a position of a NT network node of the wireless network, (b) a velocity of the NT network node, (c) a position of a terrestrial network node of the wireless network, and (d) a feeder link delay associated with a feeder link between the terrestrial network node and the NT network node. In such cases, the synchronization information may be valid at the implicit time reference which is a fixed reference corresponding to the NT network node or the terrestrial network node.

In some implementations, the position and the velocity may be according to ECEF coordinates.

In some implementations, the synchronization information may be valid at the implicit time reference which is a fixed reference corresponding to the NT network node or the terrestrial network node.

In some implementations, the implicit time reference may correspond to a frame boundary at or immediately after an ending boundary of a system information window in which a corresponding SIB is transmitted from the wireless network to communication apparatus 210.

In some implementations, the implicit time reference may correspond to a frame boundary at a starting boundary, a fixed offset from the starting boundary, or a fixed offset from an ending boundary of a frame or slot in which a corresponding SIB is transmitted from the wireless network to communication apparatus 210.

In some implementations, in determining the feeder link delay, process 500 may involve processor 212 receiving, via transceiver 216 and from the wireless network, a signaling indicating the feeder link delay at a reference time and a feeder link delay drift rate at the reference time.

In some implementations, in maintaining the synchronization using the feeder link delay, process 500 may involve processor 212 deriving the feeder link delay at a given time based on the feeder link delay at the reference time, the feeder link delay drift rate at the reference time, and an amount of time elapsed from the reference time to the given time.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
determining, by a processor of an apparatus, synchronization information with respect to an implicit time reference associated with a wireless network; and
maintaining, by the processor, synchronization using the synchronization information in performing non-terrestrial network (NTN) communications with the wireless network.

2. The method of claim 1, wherein the synchronization information comprises one or more of:
a position of a non-terrestrial (NT) network node of the wireless network,
a velocity of the NT network node,
a position of a terrestrial network node of the wireless network, and
a feeder link delay associated with a feeder link between the terrestrial network node and the NT network node.

3. The method of claim 2, wherein the position and the velocity are according to Earth-Centered, Earth-Fixed (ECEF) coordinates.

4. The method of claim 1, wherein the synchronization information is valid at the implicit time reference which is a fixed reference corresponding to the NT network node or the terrestrial network node.

5. The method of claim 1, wherein the implicit time reference corresponds to a frame boundary at an ending boundary of a system information window in which a corresponding system information block (SIB) is transmitted from the wireless network to the apparatus.

6. The method of claim 1, wherein the implicit time reference corresponds to a frame boundary immediately after an ending boundary of a system information window in which a corresponding system information block (SIB) is transmitted from the wireless network to the apparatus.

7. The method of claim 1, wherein the implicit time reference corresponds to a frame boundary at a starting boundary of a frame or slot in which a corresponding system information block (SIB) is transmitted from the wireless network to the apparatus.

8. The method of claim 1, wherein the implicit time reference corresponds to a frame boundary at a fixed offset from a starting boundary of a frame or slot in which a corresponding system information block (SIB) is transmitted from the wireless network to the apparatus.

9. The method of claim 1, wherein the implicit time reference corresponds to a frame boundary at a fixed offset from an ending boundary of a frame or slot in which a corresponding system information block (SIB) is transmitted from the wireless network to the apparatus.

10. A method, comprising:
determining, by a processor of an apparatus, a feeder link delay associated with a feeder link between a terrestrial network node and a non-terrestrial (NT) network node of a wireless network; and
maintaining, by the processor, synchronization using the feeder link delay in performing non-terrestrial network (NTN) communications with the wireless network.

11. The method of claim 10, wherein the determining of the feeder link delay comprises receiving, from the wireless network, a signaling indicating the feeder link delay at a reference time and a feeder link delay drift rate at the reference time.

12. The method of claim 11, wherein the maintaining of the synchronization using the feeder link delay comprises deriving the feeder link delay at a given time based on the feeder link delay at the reference time, the feeder link delay drift rate at the reference time, and an amount of time elapsed from the reference time to the given time.

13. A method, comprising:
determining, by a processor of an apparatus, either or both of:
synchronization information with respect to an implicit time reference associated with a wireless network, and
a feeder link delay associated with a feeder link between a terrestrial network node and a non-terrestrial (NT) network node of the wireless network; and
maintaining, by the processor, synchronization using either or both of the synchronization information and the feeder link delay in performing non-terrestrial network (NTN) communications with the wireless network.

14. The method of claim 13, wherein the synchronization information comprises one or more of:
a position of a non-terrestrial (NT) network node of the wireless network,
a velocity of the NT network node,
a position of a terrestrial network node of the wireless network, and
a feeder link delay associated with a feeder link between the terrestrial network node and the NT network node,
wherein the synchronization information is valid at the implicit time reference which is a fixed reference corresponding to the NT network node or the terrestrial network node.

15. The method of claim 14, wherein the position and the velocity are according to Earth-Centered, Earth-Fixed (ECEF) coordinates.

16. The method of claim 13, wherein the synchronization information is valid at the implicit time reference which is a fixed reference corresponding to the NT network node or the terrestrial network node.

17. The method of claim 13, wherein the implicit time reference corresponds to a frame boundary at or immediately after an ending boundary of a system information window in which a corresponding system information block (SIB) is transmitted from the wireless network to the apparatus.

18. The method of claim 13, wherein the implicit time reference corresponds to a frame boundary at a starting boundary, a fixed offset from the starting boundary, or a fixed offset from an ending boundary of a frame or slot in which a corresponding system information block (SIB) is transmitted from the wireless network to the apparatus.

19. The method of claim 13, wherein the determining of the feeder link delay comprises receiving, from the wireless network, a signaling indicating the feeder link delay at a reference time and a feeder link delay drift rate at the reference time.

20. The method of claim 19, wherein the maintaining of the synchronization using the feeder link delay comprises deriving the feeder link delay at a given time based on the feeder link delay at the reference time, the feeder link delay drift rate at the reference time, and an amount of time elapsed from the reference time to the given time.
